(19) United States
(12) Patent Application Publication
(10) Pub. No.: US 2016/0318163 A1
(43) Pub. Date: Nov. 3, 2016

(54) IMPACT TOOL

(71) Applicant: HITACHI KOKI CO., LTD., Tokyo (JP)

(72) Inventors: Yoshihiro KOMURO, Ibaraki (JP); Kengo TAMURA, Ibaraki (JP)

(73) Assignee: Hitachi Koki Co., Ltd., Tokyo (JP)

(21) Appl. No.: 15/106,144

(22) PCT Filed: Dec. 15, 2014
(86) PCT No.: PCT/JP2014/006239

§ 371 Date: Jun. 17, 2016

(30) Foreign Application Priority Data
Dec. 20, 2013 (JP) 2013-263767

(51) Int. Cl. B25B 21/02; B25F 5/00

(52) U.S. Cl. CPC B25B 21/02; B25F 5/001

(57) ABSTRACT

An impact tool includes: a spindle which makes a rotation motion; a hammer which makes a reciprocating motion in a longitudinal direction; a spring whose front end is supported on the hammer side and rear end is supported on the spindle side; and a stopper fixed to the spindle so that it abuts on the hammer when the hammer is moved rearward, and the rear end of the spring and the stopper are mutually overlapped with each other in the longitudinal direction.

### TECHNICAL FIELD

The present invention relates to impact tools such as an impact driver and an impact wrench.

### BACKGROUND ART

Impact tools using an electric motor or a pneumatic motor as a driving source have been known. Impact tools apply an impact force and a rotational force to an object such as a screw, bolt, nut or the like. Patent Literature 1 discloses a structure of an impact driver that is one of the impact tools. FIG. 1 is a cross-sectional view showing a structure of a portable electric impact driver. FIG. 1 shows a cross section of an impact driver 200 taken along the rotation axis of an anvil 22. This impact driver 200 has a handle 10 that is held by a worker during use. On an upper side of the handle 10, a housing 20 in which a motor 21 serving as a driving source and the like are installed is provided. On a lower side of the handle 10, a battery attachment unit 30 to which a battery 300 serving as a power source is attached is provided. The battery 300 includes a plurality of lithium ion cells. At a right end of the housing 20, the anvil 22 to which a socket and the like (not shown) are attached is provided, and this anvil 22 is rotatably supported by a metal bush 221. When a switch 11 is turned on, the motor 21 is rotated, so that an impact force in a forward direction (right direction in the figure) is applied to the anvil 22 and a rotational force (rotation torque) around a rotation axis is also applied to the anvil 22. Thus, the work of tightening and loosening a bolt and a nut can be done with a socket attached to the anvil 22.

Inside the housing 20, a mechanism for converting the rotational driving force output from the motor 21 into the above-mentioned impact force and rotational force is provided. A rotation shaft 211 of the motor 21 extends in a longitudinal direction (lateral direction in the figure). The rotation shaft 211 is supported by a bearing 212 inside the housing 20 and is connected to a planetary gear deceleration mechanism 23. In the planetary gear mechanism 23, the rotation motion of an inner gear 231 attached to the rotation shaft 211 is transmitted to an outer gear 233 through a plurality of planetary gears 232 provided on the outside of the inner gear 231. In this case, since the outer gear 233 is fixed, a planetary gear shaft 234 that is the rotation shaft of each of the planetary gears 232 revolves in conjunction with the rotation of the inner gear 231. More specifically, the revolution of the planetary gear shaft 234 is taken out as an output.

The plurality of planetary gear shafts 234 are fixed to a spindle 74, and when the motor 21 (rotation shaft 211) rotates, the spindle 74 rotates at a predetermined deceleration ratio. The spindle 74 includes a spindle shaft portion 741 having a substantially cylindrical shape which protrudes forward and a carrier portion 742 having a flange shape which is provided on a rear side of the spindle shaft portion 741 and expands outward of the spindle shaft portion 741.

A hammer 25 is attached to the spindle shaft portion 741 from the front side (right side in the figure), and an outer peripheral surface of the spindle shaft portion 741 and an inner peripheral surface of the hammer 25 are in contact with each other. In this case, on the outer peripheral surface of the spindle shaft portion 741 having the substantially cylindrical shape, a spindle cam groove 743 having a V shape is formed. Moreover, on the inner peripheral surface of the hammer 25 that is in contact with the outer peripheral surface of the spindle shaft portion 741, a hammer cam groove 251 having a V shape corresponding to the spindle cam groove 743 is formed. Between the spindle shaft portion 741 and the hammer 25, a V shaped hole is formed by combining the spindle cam groove 743 and the hammer cam groove 251 with each other. The spindle shaft portion 741 and the hammer 25 are engaged with each other via a ball 26 put into the hole. In conjunction with the movement of the ball 26 in the hole, the hammer 25 makes reciprocating motions in the longitudinal direction (lateral direction in the figure) as well as rotation motions. The hammer 25 and the spindle 74 can rotate at different rotation speeds from each other. When the hammer 25 rotates at a rotation speed different from that of the spindle 74, the hammer 25 moves in the longitudinal direction. By the movement of the hammer 25 in the longitudinal direction, the relative positional relationships between the hammer 25 and the spindle 74 and between the hammer 25 and the anvil 22 are changed.

Moreover, the planetary gear shaft 234 serving as the rotation shaft of the planetary gear 232 in the planetary gear deceleration mechanism 23 is inserted and fixed in the hole formed in the carrier portion 742 of the spindle shaft portion 741. A spring 27 is provided between the hammer 25 and the carrier portion 742, and a front end of the spring 27 is supported by the hammer 25 side and a rear end thereof is supported by the spindle 74 (carrier portion 742) side. Moreover, on the front side of the hammer 25 (right side in the figure, that is, the anvil 22 side), a hammer claw 252 is provided. When the hammer 25 that moves in the longitudinal direction is located on the front side, an anvil blade 222 formed on the rear side of the anvil 22 and the hammer claw 252 are meshed with each other, so that the rotation of the hammer 25 is transmitted to the anvil 22. On the other hand, when the hammer 25 is located on the rear side, the anvil blade 222 and the hammer claw 252 are not meshed with each other, so that the hammer 25 rotates idly.

When the motor 21 rotates in the state where the spring 27 is extended (in the state where the hammer 25 is located forward), the spindle 74 and the hammer 25 are integrally rotated. Moreover, in this state, the hammer claw 252 and the anvil blade 222 are meshed with each other. Therefore, the spindle 74, the hammer 25 and the anvil 22 are rotated integrally. At this time, when the socket attached to the anvil 22 abuts on a bolt or a nut to start its tightening, a reaction torque is exerted on the anvil 22. Consequently, since the spindle 74 continues to rotate while the anvil 22 is decelerated, the difference in rotation speed is caused between the hammer 25 engaged with the anvil 22 and the spindle 74. Due to the difference in rotation speed, the ball 26 moves inside the V shaped hole and the hammer 25 retreats toward the carrier portion 742 (toward the left side in the figure). At this time, the spring 27 is compressed.

When the hammer 25 retreats, the meshing between the hammer claw 252 and the anvil blade 222 is released, so that the torque is no longer transmitted to the anvil 22. However, the spindle 74 continues to rotate even thereafter. After the hammer 25 reaches the maximum retreat position and the compression amount of the spring 27 is maximized, the hammer 25 advances forward in conjunction with the movement of the ball 26 inside the V shaped hole. At this time, a restoring force (reaction force) of the spring 27 is applied to the hammer 25. Consequently, the hammer claw 252 and the anvil blade 222 are abruptly meshed with each other again, so that the anvil 22 is driven again. At this time, by the collision of the hammer 25 (hammer claw 252), a large impact force is applied to the anvil 22. Then, forward large impact force and large torque are applied to a bolt or a nut on which the socket attached to the anvil 22 abuts.

The above-mentioned operation of the anvil 22 is realized by the rotation motion and reciprocating motion of the hammer 25 on an extension line of the rotation shaft 211. Therefore, in order to apply an appropriate impact force to the anvil 22, it is necessary to ensure a certain degree of the stroke amount of the reciprocating motion of the hammer 25. Moreover, it is also necessary to sufficiently enhance the precision of the motion of the hammer 25 including the rotation motion. Furthermore, at the time when the hammer 25 reaches the maximum retreat position, the ball 26 collides with a cam rear end portion 744 corresponding to the rearmost portion of the V shaped hole or the hammer 25 collides with the carrier portion 742. Therefore, it is necessary to alleviate the impact at this time. For this reason, a contrivance to satisfy the above-mentioned demands has been made for a portion where the hammer 25 and the spindle 74 come in contact with each other. FIG. 2 is an enlarged view showing a structure in the vicinity of the hammer 25 and the spindle 74. Although FIG. 2 mainly shows the structure below the rotation shaft, the structure above the rotation shaft is symmetric to the structure below the rotation shaft.

As shown in FIG. 2, on the front side (right side in the figure) of the carrier portion 742, a stopper 51 and a washer 81 are attached to the periphery of the spindle shaft portion 741. The stopper 51 is formed of an elastic material into a disk-like shape, and the spindle shaft portion 741 penetrates in the center of the stopper 51. The stopper 51 alleviates an impact of the collision between the hammer 25 that has reached the maximum retreat position and the carrier portion 742, by which the impact of the collision between the cam rear end portion 744 and the ball 26 is alleviated. The washer 81 has a stepped shape. Concretely, the washer 81 includes a washer front end portion 811, a washer rear end portion 812 that is formed on the outer side than the washer front end portion 811, and a washer raised portion 813 that connects these portions with each other. As shown in the figure, the stopper 51 is covered with the washer front end portion 811 and the washer raised portion 813 from the front side, and fixed on the outside of the spindle shaft portion 741. Moreover, the washer raised portion 813 is surrounded by the rear end side of the spring 27, and the rearmost end of the spring 27 is supported by the front surface of the washer rear end portion 812. More specifically, the washer 81 functions also as a spring supporting member. Furthermore, the planetary gear shaft 234 penetrates through the hole formed in the carrier portion 742, and is supported and fixed by the back surface of the washer rear end portion 812.

As described above, the stopper 51, the spring 27 and the planetary gear shaft 234 are fixed by using the washer 81. Therefore, the position of the washer 81 in the radial direction of the spindle 74 is important. In other words, the distance of the washer 81 from the center axis of the spindle 74 is important. For this reason, a step portion that protrudes toward the front side is formed on the front surface of the carrier portion 742, and the stopper 51 is attached to this step portion. The step portion to which the stopper 51 is attached is covered with the washer 81 from the front side. In FIG. 2, a cavity is formed between the stopper 51 and the planetary gear shaft 231. However, at a position not shown in FIG. 2 (position where no planetary gear shaft 231 is present), the portion corresponding to this cavity is formed as a part of the carrier portion 742. More specifically, in order to precisely fix the washer 81 to the spindle 74, a step difference corresponding to the washer raised portion 813 is formed in the carrier portion 742, and the height of the step portion in the longitudinal direction (lateral direction in the figure) is denoted by La. Thus, the inner surface of the washer raised portion 813 is in contact with the outer peripheral surface of the step portion, so that both of the stopper 51 and the washer 81 are fixed to the spindle 74.

When the step difference La is small, the contact area between the inner surface of the washer raised portion 813 and the outer peripheral surface of the step portion becomes small, with the result that the fixing precision of the washer 81 is deteriorated. Therefore, the step difference La is preferably set to, for example, 1 mm or more. As can be seen from FIG. 2, the length of the washer raised portion 813 in the longitudinal direction needs to be a length corresponding to the step difference La and the thickness of the stopper 51. In order to sufficiently absorb the impact, the stopper 51 needs to have a thickness of, for example, about 1 mm, and in this case, the length of the washer raised portion 813 in the longitudinal direction is set to, for example, 2 mm or more.

By fixing the washer 81 to the spindle 24 with high precision, it becomes possible to fix the stopper 51, the rear end portion of the spring 27, the planetary gear shaft 234 and the like with high precision. Consequently, the hammer 25 can be operated with high precision.

### CITATION LIST

### Patent Literature

[PTL 1]

Japanese Patent Application Laid-Open Publication No. 2013-208678

### SUMMARY OF INVENTION

### Technical Problem

In the structure shown in FIG. 2, the maximum retreat position of the hammer 25 is determined by the position of the stopper 51. On the other hand, the position of the rear end portion of the spring 27 is located on further rear side than the stopper 51. Therefore, the shape of the spindle 74 (carrier portion 742) needs to be formed into a shape corresponding to the position of the rear end portion of the spring 27. More specifically, in the above-mentioned structure, when the step difference La is increased so as to fix the washer 81 to the spindle 74 with high precision, the total length of the spindle 74 needs to be increased.

However, the increase of the total length of the spindle 74 hinders the size reduction and the weight reduction of the entire device. Alternatively, when a predetermined length of La is ensured, with the total length of the spindle 74 being determined, there is fear that the amount of stroke of the hammer 25 is reduced and a desired impact force cannot be obtained.

That is, it has been difficult to achieve the size reduction of an impact tool, while ensuring the precise motion of a hammer.

The present invention has been made in view of these problems, and an object of the present invention is to solve the above-mentioned problems.

### Solution to Problem

In an aspect of the present invention, an impact tool includes: a spindle which makes a rotation motion; a hammer which makes a reciprocating motion in a longitudinal direction; a spring whose front end is supported on the hammer side and rear end is supported on the spindle side; and a stopper fixed to the spindle so that it abuts on the hammer when the hammer is moved rearward, and the rear end of the spring and the stopper are mutually overlapped with each other in the longitudinal direction.

### Advantageous Effects of Invention

According to the present invention, it is possible to achieve the size reduction of an impact tool, while ensuring the precise motion of a hammer.

### BRIEF DESCRIPTION OF DRAWINGS

FIG. 1 is a cross-sectional view showing a conventional impact driver.

FIG. 2 is a cross-sectional view showing a peripheral structure of a hammer and a spindle in the conventional impact driver.

FIG. 3 is a cross-sectional view showing an impact driver to which the present invention is applied.

FIG. 4 is a cross-sectional view showing a peripheral structure of a hammer and a spindle in the impact driver to which the present invention is applied.

FIG. 5A is a cross-sectional view showing a relationship between a spindle and a washer in the impact driver to which the present invention is applied.

FIG. 5B is a front view showing a relationship between the spindle and the washer in the impact driver to which the present invention is applied.

FIG. 6A is a cross-sectional view showing a modified example of the impact driver to which the present invention is applied.

FIG. 6B is a cross-sectional view showing a peripheral structure of a hammer and a spindle in the impact driver shown in FIG. 6A.

### DESCRIPTION OF EMBODIMENTS

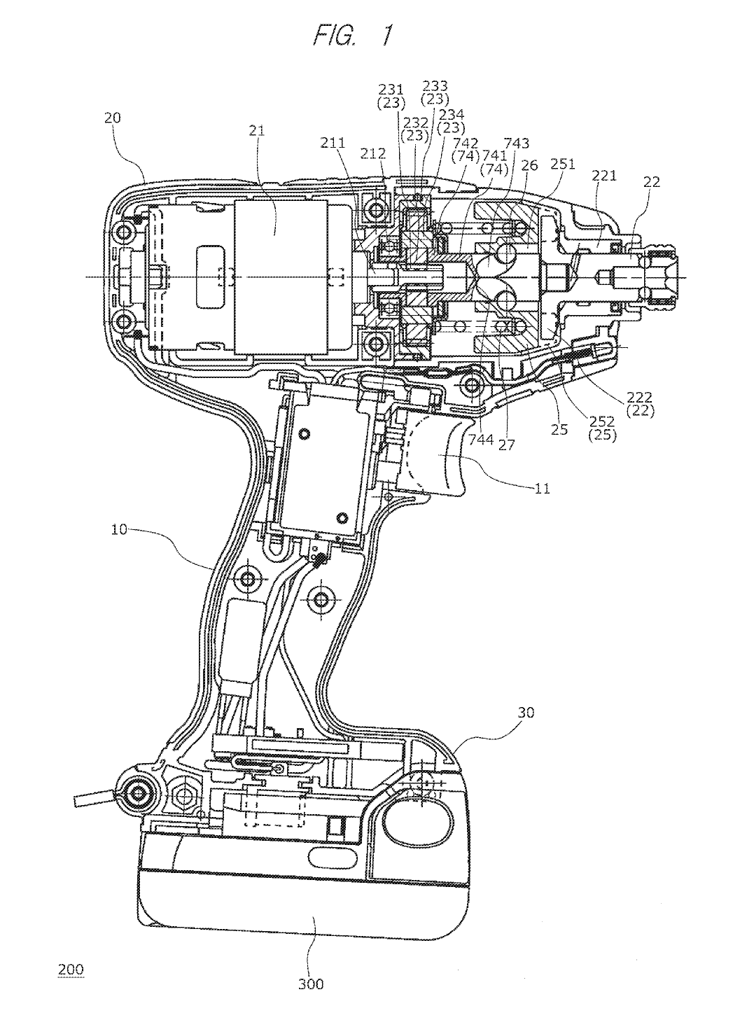

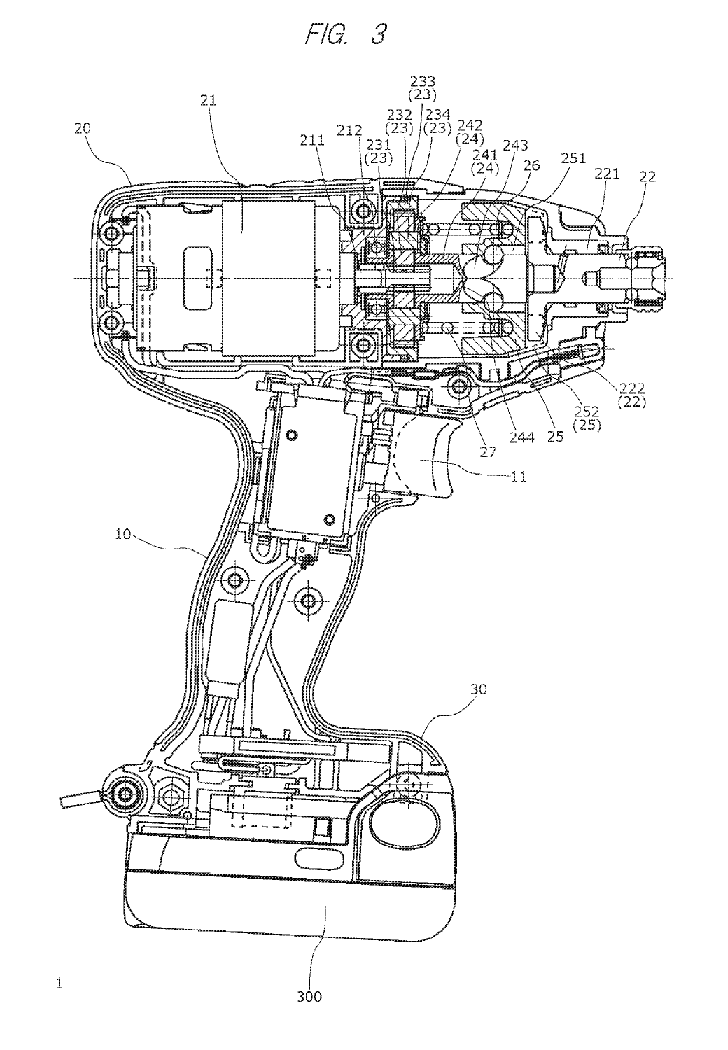

One example of an impact driver (impact tool) to which the present invention is applied will be described. FIG. 3 is a cross-sectional view of the impact driver 1 and corresponds to FIG. 1. Like the impact driver 200 mentioned above, the impact driver 1 includes the handle 10, the housing 20 and the battery attachment unit 30, and the battery 300 is attached to the battery attachment unit 30. The motor 21, the anvil 22, the planetary gear mechanism 23, the hammer 25 and the like housed in the housing 20 are also the same as those provided in the impact driver 200. The structure in which the anvil 22 is driven via the spindle 24 and the hammer 25 is also the same as the structure mentioned above. Concretely, the spindle 24 includes a spindle shaft portion 241 and a carrier portion 242. A spindle cam groove 243 is formed on the spindle shaft portion 241, and the spindle cam groove 243 and a hammer cam groove 251 are combined with each other. The motions of the spindle 24, the hammer 25 and the anvil 22 in the impact driver 1 are the same as the motions of those in the impact driver 200 mentioned above. The spring 27 and the stopper 51 are used for the same purpose as that in the impact driver 200 mentioned above.

However, in this impact driver 1, the rear end portion of the spring 27 or the front surface of the spring supporting member which supports the rear end portion of the spring 27 is not located on further rear side than the stopper 51. In the impact driver 1, the rear end portion of the spring 27 or the front surface of the spring supporting member which supports the rear end portion of the spring 27 is located at a position that is overlapped with the stopper 51 in the longitudinal direction. For this reason, the total length of the spindle 24 can be shortened.

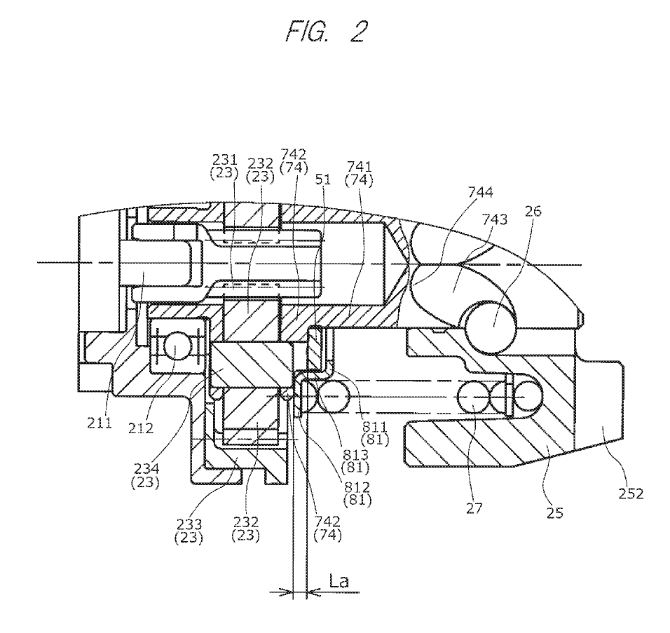

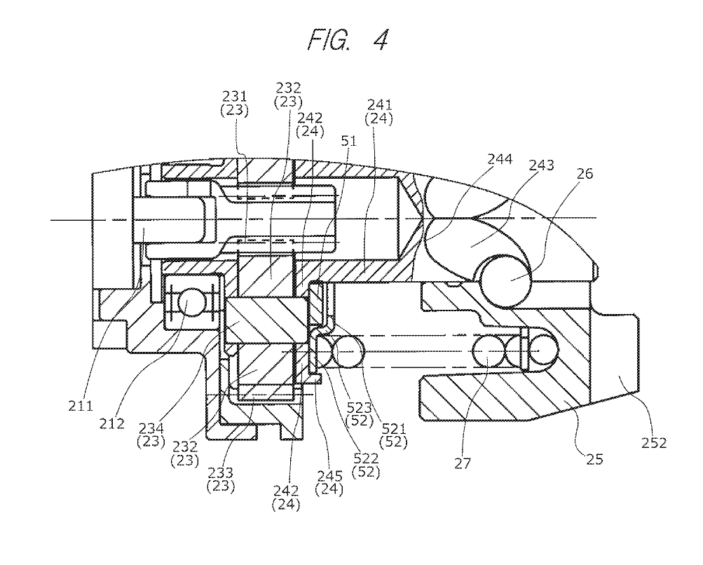

FIG. 4 is an enlarged view showing a peripheral structure of the hammer 25 and the spindle 24 in the impact driver 1 and corresponds to FIG. 2. The stopper 51 and the washer (spring supporting portion) 52 shown in FIG. 4 are used for the same purpose as that in the impact driver 200 mentioned above. The stopper 51 is fixed to the spindle 24 by the washer 52. Moreover, the planetary gear shaft 234 is fixed by the washer 52 from the front side. Therefore, the fact that the precision of the fixing of the washer 52 to the spindle 24 is important is also the same as the case of the impact driver 200 mentioned above.

The washer 52 has a stepped shape. Concretely, the washer 52 includes a washer front end portion 521, a washer rear end portion 522 that is formed on the outer side than the washer front end portion 521, and a washer raised portion 523 that connects these portions with each other. The configuration and function of the washer 52 are the same as those of the washer 81. However, the fixing method of the washer 52 to the carrier portion 24 is different from the fixing method mentioned above. Therefore, the length of the washer raised portion 523 in the longitudinal direction is greatly different from that of the washer raised portion 813 mentioned above.

In the impact driver 1, the positioning (fixing) of the washer 52 to the carrier portion 242 is made by a washer locking portion 245 provided on the outer periphery of the carrier portion 242. The washer locking portion 245 protrudes toward the front side (right side in the figure) on the outer periphery of the carrier portion 242, and supports the washer rear end portion 522 from the outside. More specifically, the washer 52 is fitted to the spindle 24 and the inner surface of the washer locking portion 245 formed on the spindle 24 (carrier portion 242) is in contact with the outer peripheral surface of the washer rear end portion 522 of the washer 52. For this reason, a step difference for fixing the washer 52 needs not to be provided on the carrier portion 242. Moreover, the length of the washer raised portion 523 in the longitudinal direction can be shortened to a minimum length required for fixing the stopper 51. In other words, the length La shown in FIG. 2 can be reduced to 0 (zero). On the other hand, although the washer locking portion 245 needs to be formed on the carrier portion 242, it is easy to avoid the interference between the washer locking portion 245 and the hammer 25 when the hammer 25 has reached the maximum retreat position. Therefore, the washer locking portion 245 does not give any adverse effects to the operations of the spindle 24 and the hammer 25.

Accordingly, it is not necessary to lengthen the spindle 24 in the longitudinal direction. Thus, it is possible to achieve the size reduction of the impact driver 1. Alternatively, it is possible to increase the amount of stroke of the hammer 25 without increasing the total length of the spindle 24. Therefore, a strong impact force can be applied to the anvil 22. Moreover, since the washer 52 can be attached to the spindle 24 with high precision, the precision of the motion of the hammer 25 can be improved.

Note that it is not necessary to form the washer locking portion 245 shown in FIG. 4 over the entire periphery of the washer 52. The length and the number of washer locking portions 245 can be desirably determined, as long as the position of the washer 52 can be fixed. For example, the washer locking portions 245 may be formed at 4 positions locally in the circumferential direction of the washer 52.

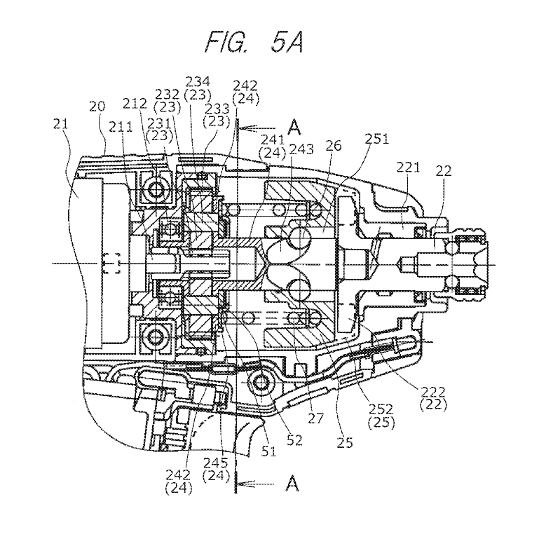

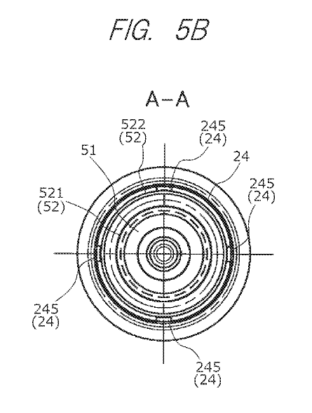

In the example shown in FIG. 5A and FIG. 5B, the plurality of washer locking portions 245 are formed in the region of the carrier portion 242 corresponding to the outer periphery of the washer 52 (washer rear end portion 522). Concretely, each of the washer locking portions 245 is formed on the upper and lower sides and right and left sides of the region mentioned above. The washer locking portions 245 are formed at four positions on the carrier portion 242, but the washer locking portions 245 may be formed at five positions or more or at three positions on the carrier portion 242. Moreover, the intervals between the plurality of washer locking portions 245 are not necessarily equal to each other.

In the above-mentioned embodiment, the outer peripheral portion of the washer 52 (washer rear end portion 522) is supported by the spindle 24 (carrier portion 242). For this reason, although the washer locking portion 245 is formed on the carrier portion 242, the basic structure of the washer 52 is the same as the conventional washer 81.

However, it is also possible to make the spindle support the outer periphery of the washer by changing the shape of the washer in place of forming the washer locking portion on the spindle. Also in this case, the total length of the spindle is shortened.

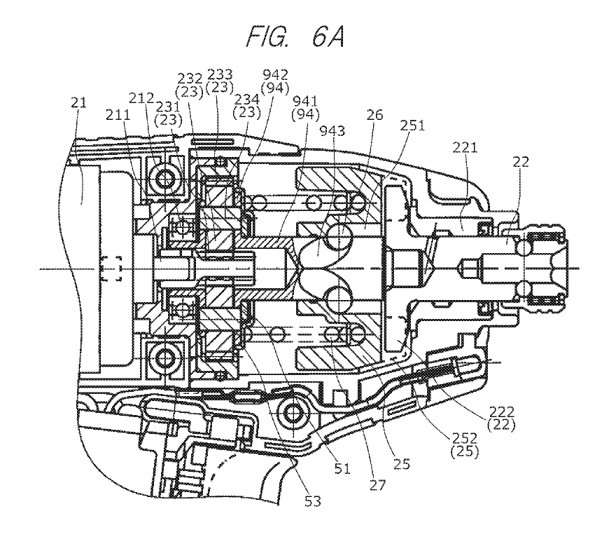

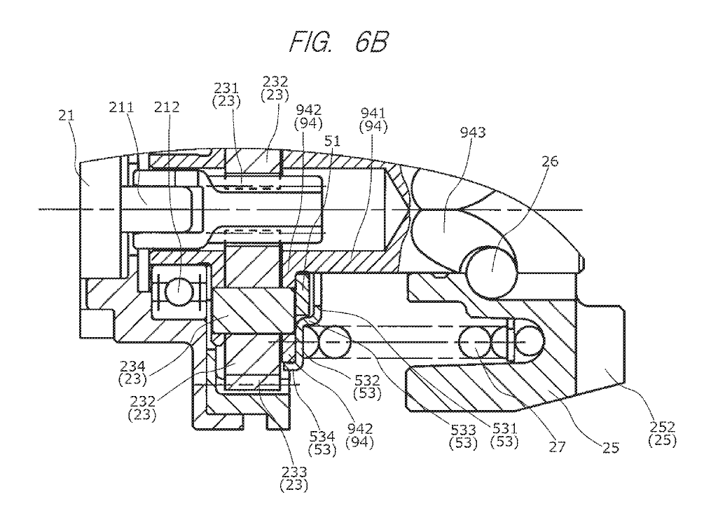

A spindle 94 shown in FIG. 6A and FIG. 6B also includes a spindle shaft portion 941, a carrier portion 942 and a spindle cam groove 943. However, the shape of the carrier portion 942 is different from that of the carrier portion 243 mentioned above. Concretely, no washer supporting portion is formed on the carrier portion 942. In short, in the spindle 94, no special structure for supporting the washer including the step difference in the conventional spindle 74 is formed.

On the other hand, the shape of the washer 53 shown in FIG. 6A and FIG. 6B is different from those of the washers 52 and 81 mentioned above. The washer 53 also has a stepped shape like the washer 52 mentioned above. Concretely, the washer 53 includes a washer front end portion 531, a washer rear end portion 532 that is formed on the outer side than the washer front end portion 531, and a washer raised portion 533 that connects these portions with each other. In the washer 53, however, a spindle supporting portion 534 that protrudes rearward (left side in the figure) is provided on the outside of the washer rear end portion 532. The spindle supporting portion 534 abuts on the outer peripheral surface of the carrier portion 942. Therefore, the washer 53 can be fitted to the spindle 94 so that the outer peripheral surface of the carrier portion 942 is in contact with the inner surface of the spindle supporting portion 534 in the washer 53, thereby fixing the washer 53 to the spindle 94.

As can be seen from FIG. 6B, the spindle supporting portion 534 that protrudes rearward from the washer 53 does not disturb the operations of the spindle 94 and the hammer 25. Moreover, the washer 53 can be attached to the spindle 94 with high precision and the total length of the spindle 94 is not increased.

It is not necessary to form the spindle supporting portion 534 over the entire periphery of the washer 53 (washer rear end portion 532). It is also possible to separately form a plurality of spindle supporting portions 534 along the circumferential direction of the washer 53.

In the embodiments mentioned above, the washers 52 and 53 function as spring supporting portions. Concretely, a part of each of the washers 52 and 53 (front surfaces of washer rear end portions 522 and 532) supports the rear end portion of the spring 27. Moreover, another part of each of the washers 52 and 53 supports the planetary gear shaft 234 and fixes the stopper 51. However, another member fixed to the spindle may support the planetary gear shaft 234 and fix the stopper 51.

In the present specification, the present invention has been described by taking an impact driver as an example. However, the present invention contributes to the size reduction and weight reduction of a device provided with a spindle and a hammer which are operated in the same manner as the spindle and the hammer mentioned above. More specifically, the present invention is effectively applied to overall impact tools provided with a spindle and a hammer. For example, the present invention is effectively applied also to an impact tool having a pneumatic motor (high pressure air) as a driving source.

1-12. (canceled)

13. An impact tool comprising:
a spindle which includes a spindle shaft portion extending in a longitudinal direction and a carrier portion located on a rear side of the spindle shaft portion, extending in a radially outward direction relative to the spindle shaft portion, and supporting a planetary gear mechanism and makes a rotation motion;
a hammer which is provided on an outer periphery of the spindle shaft portion and on a front side of the carrier portion and makes a reciprocating motion in the longitudinal direction with respect to the spindle;
a spring which is provided between the carrier portion and the hammer in the longitudinal direction and applies a force to the front side to the hammer; and
a washer which is provided between the carrier portion and a rear end of the spring in the longitudinal direction,
wherein the carrier portion has a through hole which supports a planetary gear shaft constituting the planetary gear mechanism,
the washer is provided so as to partially close the through hole, and
the carrier portion has a protruding portion which protrudes to the front side from a front surface of the carrier portion on a radially outer side relative to the washer.

14. The impact tool according to claim 13,
wherein the planetary gear mechanism includes an inner gear attached to a rotation shaft of a motor, a planetary gear engaged with the inner gear, an outer gear engaged with the planetary gear and the planetary gear shaft serving as a shaft of the planetary gear and supported by the carrier portion, and
the protruding portion protrudes to the front side from the front surface of the carrier portion located opposite to the planetary gear on a radially outer side relative to the planetary gear shaft.

15. The impact tool according to claim 13,
wherein the protruding portion restricts movement of the washer in a radial direction with respect to the carrier portion.

16. The impact tool according to claim 13,
wherein the through hole is located on an inner side relative to the spring in a radial direction.

17. The impact tool according to claim 13,
wherein the protruding portion is formed over an entire periphery of the carrier portion.
